(19) United States
(12) Patent Application Publication
(10) Pub. No.: US 2012/0078708 A1
(43) Pub. Date: Mar. 29, 2012

(54) System and Method for Recording and Analyzing Internet Browser Traffic Independent of Individual or Specific Digital Platforms or Websites

(76) Inventors: Kate Taylor, New York, NY (US); Ken Nanus, New York, NY (US); Joseph P. Romello, West Chester, PA (US)

(21) Appl. No.: 13/240,674

(22) Filed: Sep. 22, 2011

Related U.S. Application Data
(60) Provisional application No. 61/385,585, filed on Sep. 23, 2010.

(51) Int. Cl. G06F 15/173; G06Q 30/02

(52) U.S. Cl. 705/14.41; 709/224

(57) ABSTRACT

Systems, techniques and methods for tracking a browser session path and content providing for the reconstruction of the full path and content of a browser session. Techniques for observing, recording, storing and analyzing the total path and content of Internet browser sessions on a device as they relate to consumer/user activity for use in reporting and predicting marketing trends and understanding behavior are disclosed. The system observes, records, stores and analyzes: activity within a browser session, activity within all browser sessions on a device, activity of a user or group of users over time, session activity without invasive efforts and/or invasive codes and/or use of potential privacy invading codes/cookies on a user's computer.

### BACKGROUND

It has been reported that Internet use by Americans has grown from approximately 12% in 1995 to 79% in 2009. While television usage levels are largely unchanged, viewers watch programs at different times or on different devices. Newspaper and magazine circulation is eroding steadily. As content, users and shoppers continue their mass migration to the Internet, marketers have followed. Getting ads to consumers now requires a sophisticated understanding of their media usage and consumer habits, necessitating reliable and actionable data.

The degree of accuracy required is not currently possible with existing measurement tools.

Data must be turned into the opportunity to predict, with strong confidence, what consumers are likely to watch, read, see or buy next. Until now that has been done largely by the placing of a “cookie” on a user's computer in order to track online habits. The cookie, a line of computer code, relays information about what sites are seen, in what order, how long a site is viewed, etc. Consumers, wary of privacy, have quickly adapted and started deleting them. That's why, among many others, It has been reported that:
30% of computer users clear out their cookies monthly;
12% of computers are set to reject cookies;
An average of 2.5 distinct first-party cookies were observed per computer per site.

Typically, analytics providers insert “tags” (code snippets) into web pages for the express purpose of capturing these tags in log files for subsequent processing for a specific website. The “tags” are reported back to servers that enable subscribers to ask questions using an interface. Providers create URLs with name-value pairs on a source site such that the clicking of the URL will, on the target site, record the fact that the browser was on the previous click at the source site. Additionally, analytics providers create tags and URLs as described above which when clicked by a user in a browser will go to an intermediate site that records the site that the click came from and the target site to which the browser was instructed to go by the user.

To obtain this information, analysts evaluate which tags are important and should be placed. This means that tags are purely website specific, a shortcoming in the current state of the art, since they relate only to the use of an individual site, rather than the role an individual site plays in a consumer's overall decision/evaluation process. By its very nature the strategy, execution and current technology for this process inhibits marketers from anticipating customer needs or market changes. This means that it prevents marketers and advertisers from measuring trends in behavior or activity on earlier occasions, since those pages and/or sites may not have been properly tagged. Full timelines are not available in the current state of the analytics art.

The current state of the analytics art, as practiced by major vendors including but not limited to Omniture, Web Trends, Core Metrics, Nielsen and others, is to report what is termed “last click attribution.” This term describes Internet usage wherein each consumer activity on the Internet is attributable to the one that preceded it. This means that a target site can see all visitors to that target site from the last site that “referred” them to the target. This method of tracking the browser session path and content does not provide for the FULL reconstruction of the path and content of a browser session, since neither the tags nor the cookies from various current analytics vendors are compatible. If a user visits a website tracked by analytics Company A then visits one tracked by Company B, there is no record of the entire session because the tracking codes for the competing companies cannot communicate with or to each other.

The state of the current technology and its tools—tagging and cookies—engender inherent systemic bias against sites (and their companies) that exist to provide content and references that consumer's use daily. For example, sites like WebMD.com provide important information to consumers. However, their actual influence in consumer decision-making cannot effectively or accurately be ascertained since they can only be “last click” attributed.

Since many consumers now use the Internet from a variety of mobile devices too, the lack of actionable data can carry substantial consequences for marketers. Juniper Research has reported that the value of digital and physical goods that people buy through their mobile phones will more than double to $200 billion globally by 2012. Separately, Gartner has projected the number of mobile payment users worldwide will reach 108.6 million this year—a 54.5% increase from the 70 million in 2009.

It has been estimated that online video now takes in more than $1 billion in marketing dollars. With a growth rate outpacing other web ad segments, eMarketer predicts that advertising spending on online video ads will amount to $5.2 billion by 2013 and account for 11% of internet spending.

Last click attribution has profound consequences for marketers, technicians and website analysts for search as well. The ability to correlate search terms with content consumed, opinions registered/communicated and products purchased is essential to a full understanding of consumer behavior. Search—through a search engine site like Google, Yahoo, Ask.com or many others—accounts for almost 65% of all digital activity. Consumers and business people often use search as a method to begin researching a specific topic or product. Leading analytics vendors practicing the current state of the art such as Omniture, Web Trends, Core Metrics and Nielsen, among many others, use cookies and tags that do not communicate with or to each other. Therefore, they cannot provide a clear picture of how or why a user made decisions on which sites to view, content to consume/read, communication to create or products to buy.

Marketers who desire to create a complete picture of consumer behavior need to understand the role that social networks play in consumer and business decisions. The ability to correlate activity on social networking websites with content consumed, opinions registered/communicated and products purchased is essential to a full understanding of consumer behavior. Social network sites have become an important aspect of digital consumption. Sites like MySpace.com, Foursquare.com and Facebook.com enjoy enormous amounts of usage yet provide limited analytic capabilities to marketers. Facebook claims over 500,000,000 worldwide users. It is reported that advertising spending on social networks will exceed $1.7 billion in 2010, more than a 20% increase from 2009.

Since it is considered the current state of the art, social networks employ the same system of “cookies” and “tags” as the rest of the Internet. However, social networks require a minimum of a week to report detailed user information to advertisers and cannot report the activity of their users on any other sites, since the cookies and tags on social network sites do not communicate with cookies and tags of other vendors.

Leading analytics vendors including Omniture, WebTrends, CoreMetrics and Nielsen, among many others cannot follow users from individual sites, across a social network while tracking that activity, then back to one or several sites that a user may utilize. Since tracking of a user's full path is unavailable, leading analytics vendors as stated above cannot correlate a user's activity on a social networking site with other Internet activity.

Since “last click attribution” is the current state of the analytics art, correlation of a user's activity over multiple Internet visits, or “sessions” over a period of time cannot be analyzed to accurately determine marketing trends or behavior nor predict future such trends or behavior.

Advertisers frequently utilize “digital ad networks” in order to place advertising across a multiple and variety of sites. These ad networks are groups of sites that an advertiser can purchase at one time. They are attractive to advertisers because they have content or user commonalities that an advertiser seeks, such as (but not limited to) demographic, lifestyle, user habits, product consumption, etc. These networks can include hundreds or even thousands of sites. Advertisers will purchase their advertising across the network as a unit.

Ad networks will provide analytic data as referenced earlier, but will only do so for their entire network, since it's not in their best interest to reveal to an advertiser which sites performed better than others. Armed with that information, an advertiser would likely bypass the ad network and buy advertising on the high-performing site(s). It is also not in the interest of the ad network to provide information showing the amount of advertising that was served on individual sites within that network, because that information might not meet with an advertiser's approval nor be in that advertiser's best interests.

Full analytics and reporting transparency is neither available from the ad networks nor the leading analytics providers practicing the state of the current art including Omniture, WebTrends, Nielsen, CoreMetrics and others. Neither can provide analytics tracking from one ad network to another unless the same company has code on all the sites in both networks.

Ad networks utilize the same “cookies”, “tags” and “last click attribution” orientation for monitoring Internet activity as referenced earlier. As a result, ad networks cannot track user behavior either 1) across multiple visits over time or 2) between networks of vendors with competing cookies or tags, since the codes therein do not communicate with each other.

Current state of the analytics art as practiced by companies like Nielsen, Omniture, WebTrends and CoreMetrics, among others, begins with a discussion of advertising “impressions”. Impressions are among the most basic metrics of advertising; measuring simply how many times advertising has been served to a given consumer or group of consumers. Advertisers often buy advertising on digital platforms based on a total number of impressions. However, when a user is at a digital device and becomes idle for some period of time (i.e., doesn't click forward or backwards to other content) the host/server will “refresh” their content, updating with content, advertising or both.

Each host/server has an individual policy for refreshing users. However, it is possible for a digital content provider to report that they have served multiple impressions to a specific user, when the user was simply idle for a short period of time. Full transparency of whether a “refreshed” ad counts as one or multiple impressions for an advertiser that has paid for just one is not available with current providers.

It has already been demonstrated that digital consumers may get their content from a home computer (or PC) and can only be tracked with cookies or tags. Further, it has been demonstrated that the leading analytics vendors, such as Omniture, Web Trends, Core Metrics and Nielsen, among many others, utilize computer code for cookies and tags that cannot communicate with that of another vendor. Therefore, last click attribution inhibits marketers' ability to understand behavior across a variety of digital platforms.

Technological advances now make it possible to consume digital content from a variety of mobile platforms, including (but not limited to) Android, iPhone, iPad, Blackberry and a host of others. Each of these mobile devices has their own operating system, with software whose tracking capabilities will not communicate with that of another. Simply put, if an iPhone user visits a site from analytics Company A then (while still on the iPhone) moves to a site tracked by analytics Company B, then goes home and looks at either (or other) site on their PC, the full path and content will be as impossible to track as if it were on a home PC. Concurrent consumption of digital content across multiple digital platforms is impossible to track by leading analytics vendors such as Omniture, Web Trends, Core Metrics and Nielsen, among many others.

Mobile devices utilize the same “cookies”, “tags” and “last click attribution” orientation for monitoring Internet activity as referenced earlier. As a result, mobile service providers cannot track user behavior either 1) across multiple visits over time or 2) between networks of vendors with competing cookies or tags, since the codes therein do not communicate with each other.

Continuing technological innovations exacerbate this process. New mobile devices are constantly being introduced, each with its own unique operating system. Many people have multiple wireless devices. Increasing numbers of people are eschewing “land lines”, i.e. the phone in the house, in favor of one or more multiple devices. Marketers need to be able to understand consumer behavior across both home computer and wireless platforms, especially since many people have both a home PC and wireless device(s).

An example will illustrate the point. If an apartment dweller wants to buy a coffee maker, he/she does not need to go anywhere. A typical e-shopping session might begin with a trip to epinions.com to view all coffee makers for apartments. Epinions.com provides many recommendations, prompting a click on one for a Keurig coffee maker. (Note—Keurig sees the session as epinions—Keurig). Unsatisfied with this item, the user goes “Back” with the back button to epinions results then, using the right mouse button, clicks on a Mr. Coffee link and “open link in a New Tab (Mr. Coffee sees the session as epinions—Mr. Coffee). If that isn't satisfactory, it's back to epinions results to type in a new tab/window www.blackanddecker.com (B&D sees the session www.blackanddecker.com).

With the decision made, the user goes to YahooShopping.com to view prices and retailers. If choices provided include Amazon, Office Depot, Sears, Target and J&R, the user might go to www.sears.com and order a coffee maker (Sears sees the session as www.sears.com).

Both Keurig and potential advertisers like Maxwell House want to know which sites and products a potential customer identified, researched then conducted a transaction. Further, such advertisers want to know how much time elapsed between the beginning of the identification phase and the subsequent transaction. This means that accurate, actionable and immediate data on site traffic for coffee makers and/or coffee products is essential.

In this case, the customer did their research on epinions and Yahoo Shopping and bought from Sears. The analytics provider for Sears will count this as a “conversion” since the customer bought the item. “Conversions” are one of the most important measurements of Internet success currently available. The “conversion” metric represents a customer who came to the site and, during that session, performed the function the designers/owners of that site desired—purchased a product, downloaded a file, entered contact information, etc. However, the limitations of the technology misrepresent the value of the Sears website—as well as the others—in the purchase process, since many other steps were taken on the way to the purchase. In the current state of the analytic art, epinions, Keurig, Mr. Coffee, Sears and Black & Decker are likely measured by different providers, making a full view of the visitor's session—and decision-making process—impossible.

In order for e-retailers and Internet marketers to fully capture customer movement across their digital channels—making their content “smart”—they have to anticipate and prepare for virtually every content consumption eventuality. For example, web publishers must install the equivalent of a “GPS” tracking device on video or flash content, which requires both time and expense along with constantly changing that tracking whenever content is updated. When that process is not followed, digital content cannot be tracked. Digital content that cannot be tracked is known as “dumb” content. It's easy to understand why more digital content, irrespective of platform, is “dumb”.

The current state of the analytics art—tagging and cookies—is used to populate a system of measurements, called metrics, of how consumers use the Internet. Website creators, whether those that have Internet stores (“e-commerce”) or have content—focused sites, utilize metrics to ascertain whether a site is achieving its objectives. The group of performance metrics, taken as a group, is known as “KPI's”, or Key Performance Indicators.

KPI's are individual and specific to each advertiser and website creator/owner, depending on the objectives sought. Among the most common KPI's are “unique visitors” (the number of different visitors to a site within a given time frame), “page views” (the number of different pages of a site that have been viewed), “total visits” (the aggregate number of times a user landed on a site) and “top referring sites” (the last site viewed before a user moved to the site in question).

Advertisers have become accustomed to the “last click attribution” model of Internet advertising and commerce. In both cases, “conversions” have become a standard goal. A “conversion” refers to a user that takes a desired action, like purchasing a product, entering personal information or downloading content. As a result, performance metrics such as “Cost per conversion (CPC)” measure the amount of money spent to achieve a single action. “Cost per unique visitor” and “cost per page view” are other common metrics.

However, the limitations of cookies and tags make these measurements specious at best. Since counts of unique visitors are derived at by counting cookies, when a user deletes their cookie, they are counted as a new, unique visitor. For example, if a user visits a site daily, and deletes his/her cookies daily, that user would show up as 30 new users for that month, a totally inaccurate measurement of performance.

Tags cannot be applied retroactively, so indicators of past usage that might indicate present or future consumption cannot be ascertained. Similarly, the trillions of permutations of future Internet content and product usage cannot be predicted in order to have tags placed in a timely or accurate manner.

“Top referring sites” could be an important indicator of how a user came to a specific site. It could also be totally coincidental and irrelevant to a user's actual intent or activity. A better measurement of the “referring sites” metric would include the entire path a user took. Unfortunately, that path is not available because analytic vendors' code cannot communicate with that of their competitors.

“Page views” tells site creators how often a particular page is being used, but reveals little of how the content on a particular page is viewed, consumed or purchased since it is the page that is measured, not the content. Individual content items must be individually tagged in order to be tracked, an expensive process requiring equally expensive constant updating.

There are existing services, methods, processes and apparatus that attempt to address these issues through the use of tagging, beacons, pixels and other types of data collection mechanisms which are inserted into the code of the pages served by the web sites. Companies such as Omniture, WebTrends and CoreMetrics provide a robust set of tools and services and are considered the current state of the art. However, all analytics companies rely on “estimates”, “samples” and/or “surveys”, since they cannot observe all Internet activity. These estimates, samples or surveys are not statistically valid, since the act of asking a question of a consumer creates bias. Question phrasings, choice of words, environment for the interview (among many other factors) all contribute to survey bias.

Overall, it is impossible to establish performance metrics that account for users' true patterns of behavior, consumption and purchase. In order to do so, it is necessary to access and, cross-reference data that state of the art analytics vendors like Omniture, CoreMetrics, Nielsen and others cannot provide, including but not limited to:

The entire path of a user's activity on the Internet via home computer;

The entire path of a user's activity on the Internet via wireless or mobile device;

Time (of day, week, month, year);

User visits;

Date of visit;

Number of pages viewed;

Type of pages viewed;

Speed of transmission;

Speed of download;

Deletion of cookies;

Type/category of site visited—content, shopping, entertainment, etc;

Current tags to a specific day;

Past tags;

Items loaded in a cart;

Items loaded in an abandoned cart;

Type of content viewed—flash, jpeg, mp3, static, pdf, etc;

Type of content downloaded—flash, jpeg, mp3, static, pdf, other;

Actual content viewed;

Actual content downloaded;

Content category—news, shopping, research, music, video, other.

Subdivisions within content category, whether viewed, downloaded or inserted into a cart—news (sports, business, weather, etc), shopping (clothes, shoes, travel, etc) research (medical, statistical, historical, etc) music (genre, artist, song, etc) video (movie, television, commercial, other), other.

Type of platform—pc, mobile, iPad, etc;

Search terms;

Blog postings;

Consumer/user generated content;

Email content sent thru http protocol;

Text messages sent through http protocol;

Time on site;

Time of session;

Sum of activities performed on site;

Elapsed time between sessions, visits, deletion of cookies and all other metrics.

The ability to cross-reference any and all the above metrics in any combination, group or combination of groups.

Thus, there is a need for improved techniques, methods and apparatus to objectively, completely, accurately and passively record, store and process the complete path and content of a dialog between a web site and the user (User dialog information or UDI) interrogating the web site in order to meet the needs of marketers to understand their customers, irrespective of language. These needs include (but are not limited to) objectively and passively collecting, observing and reporting visitor activity in order to report on actual results, trends (including search term use), products/services investigated (specific observation of products/services), behavior in terms of selecting a product/service, etc.

### SUMMARY

Embodiments herein are directed to a system and method that will:

Follow users across multiple activities (search, entertainment, etc.);

Follow users across multiple analytics vendors (Google Analytics, SAS, Omniture, etc.);

Retrieve and analyze information from prior web or mobile sessions that were not previously tagged;

Determine accurately whether advertiser impressions were delivered with one click or whether impressions are aggregated each time a server refreshes a user's site;

Calculate ad impressions independently of the networks that deliver those ads;

Relate search terms specifically to other activities;

Follow users across multiple sites without tagging;

Follow users across multiple sites without cookies;

Follow users across multiple sessions over any period of time;

Follow users across multiple digital platforms (including VOIP and mobile);

Follow users across multiple digital platforms and activities, including but not limited to search, entertainment, shopping, research, communication, etc.;

Follow users agnostically across all sites and platforms irrespective of the analytics vendor whose source code is in place on the site;

Retrieve and analyze information from prior web or mobile sessions that were not previously tagged;

Provide all information in multiple languages;

Determine accurately whether advertiser impressions were delivered with one click or whether impressions are aggregated each time a server refreshes a user's site;

Determine whether advertising delivered to a user actually appears on their screen or is rendered below the screen “fold”;

Calculate ad impressions independently of the networks that deliver those ads;

Provide accurate and comprehensive recording of web traffic across the internet;

Allow website owners to have a full picture of visitor behavior prior to, during, and following the visit to the website;

Create new methods and processes of analytics to be used to understand user behavior on the internet;

Allow real-time analysis and reporting on internet traffic;

Enable Internet marketers to utilize accurate information for timely optimization of marketing and advertising campaigns;

Create an end-to-end view of online advertising and marketing campaigns;

Create a system that does not rely on surveys and/or sampling to draw conclusions;

Create a system that does not rely on 3rd party players to speculate on behavior patterns;

Measure directly by observation the behavior patterns of visit sessions;

Capture the chronology of behavior over time across multiple locations;

Is independent and unrelated to the reporting element, ad agency, manufacturer, retailer, advertiser or anyone else involved with digital content;

Create a system that does not invade or compromise the privacy of individuals;

Reduce exposure to malware and/or viruses;

Accurately count page views by sites for specific timeframes;

Accurately count page views requested by browsers for specific timeframes;

Accurately count page views generated automatically by sites but not requested by browsers for specific timeframes;

Accurately calculate the time to serve pages to browsers based on requests for specific timeframes;

Accurately calculate the time to service browser requests by sites for specific timeframes;

Create new measurements of Internet activity based on heretofore unavailable information;

Create new measurements of Internet activity without the additional use of “panels” or “surveys”;

Create new measurements of Internet activity with a minimum of 95% statistical certainty.

### DESCRIPTION OF THE DRAWINGS

FIG. 1 is a block diagram illustrating an interaction between a browser and server according to an embodiment.

FIG. 2 is a block diagram illustrating a single browser having multiple tabs according to an embodiment.

FIG. 3 is a block diagram illustrating the interdependence between Internet Service Providers (ISP's), the websites to which they communicate and the servers from which they get their data according to an embodiment.

FIG. 4 is a block diagram illustrating a process through which a TCP packet flows.

FIG. 5 is a block diagram illustrating a distribution of capture appliances according to an embodiment.

FIG. 6 is a block diagram illustrating an interface of a capture appliance to an existing network using a tap according to an embodiment.

FIG. 7 is a block diagram illustrating the volume of data generated for analysis according to embodiments.

FIG. 8 is a chart illustrating a hierarchy for data collection according to an embodiment.

FIG. 9 is a block diagram illustrating the components of a computing device.

FIG. 10 is a block diagram illustrating the components of a server device.

### DETAILED DESCRIPTION

Data to be Collected and its Identification

In an embodiment, a browser path analyzer is operated such that a path taken by the browser (windows and/or tabs) on any device (laptop, desktop and/or device) connected to the Internet may be directly observed. During the observation of the path, essential elements of data may be collected, measures from the data elements may be derived; and those measures may be analyzed and reported.

The data collection and measure derivation operation may be completed within seconds of elapsed time from the first occurrence of a reportable event.

In an embodiment, a path evaluation system monitors the paths taken by all browsers (windows and/or tabs) on any device (laptop, desktop and/or device) connected to the Internet can be: 1) be directly observed; 2) collect essential elements of data; 3) calculate measures from the data elements derived; and, 4) analyze and report on the calculated measures.

In the discussion set forth below, the term “DBWT” refers to a Device (laptop, desktop, iPad, iPhone, etc.), a Browser (Safari, Internet Explorer, Firefox, etc.), a Window (#1, #2, #3, etc) and a Tab (#1, #2, #3, etc.).

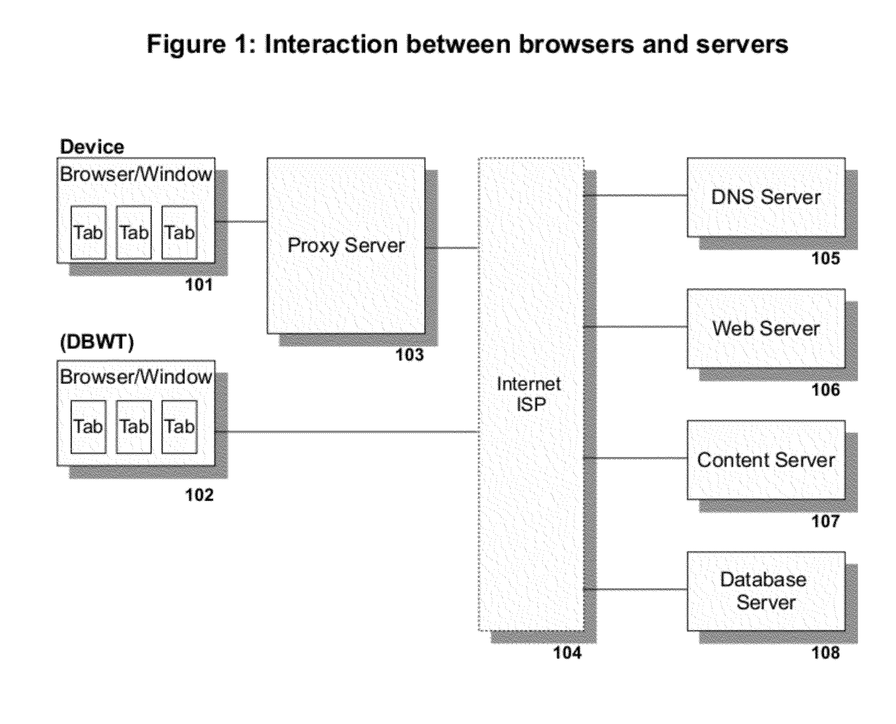

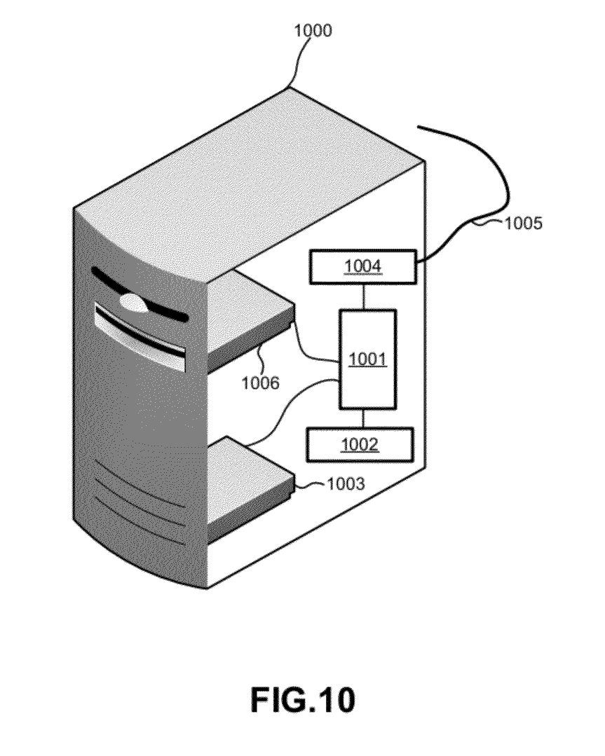

Embodiments are discussed below with references to FIGS. 1-10. However, those skilled in the art will readily appreciate that the detailed description given herein with respect to these figures is for explanatory purpose and is not intended to be limiting.

The recording of data is done at the network packet level since this is the native level by which the DWBT and the target website interact physically and logically.

FIG. 1 is a block diagram illustrating an interaction between a browser and server according to an embodiment.

Referring to FIG. 1, an interaction between the browser and a server are illustrated. This interaction provides the basis for the collection of data and the subsequent analysis.

A website session is a series of http requests that provide the complete dialog between a DBWT and a specific web site. A DBWT visit path is the sequence of sessions, chronologically between a DBWT and all websites visited. Possible session/visit-ending events could include (but not be limited to) the user closing the specific tab, the device losing power or termination of the Internet connection to the device.

A browser typically performs a three-step process: 1) A browser will find the IP address for the domain; 2) Request the index.html page, then 3) Render the index page—which may exhibit other requests for other information. All preparatory work performed by the browser prior to requesting the index.html page of the site is conducted between the browser and the customer's Internet Service Provider (ISP).

A DWBT 101 connects to the Internet, 104, via a proxy server, 103. The proxy server, 103, enables the efficient use of IP addresses through the use of a single IP address connection to the Internet, 104, which is then shared by or more DBWTs. This configuration of 101 and 103 is typical in large companies and/or communities. A DBWT, 102, can also connect directly to the Internet, 104, and thus the IP address of the DBWT is the IP address of the connection.

At the highest level the DBWT user enters a URL into the address bar and presses the enter key. This action can be by direct typing, use of bookmarks, use of previous links stored in browsers and/or clicking on a highlighted link in an email, article, document, presentation, video, etc. The specific manner of entry is not at issue nor is it directly relevant. From the view of the browser a specific action has been requested by the user of the DWBT to “go to this address.” At that point, the DWBT now interacts with the protocols of the Internet to execute the request.

The Internet, 104, is provided by an Internet Service Provider, such as Verio, Verizon, Comcast, T-Mobile, etc. ISPs, 104, extend the Internet to DBWT through switching and efficient use of bandwidth. This is similar to the mechanisms utilized by various telephone companies to efficiently utilize the communications infrastructure to accept, connect and disconnect telephone calls between two or more parties.

When a website is typed into the address bar of the browser, the browser first sends a request to the ISP asking for the IP address of the domain. An IP address serves two principal functions: host or network interface identification and location addressing. The domain is the word in front of the final third of the address—“.com”, “.org”, “.tv”, “.co.uk”, etc.

When a DBWT, 101 or 102, makes an HTTP (Hypertext Transport Protocol) request for a website, the DBWT, 101 or 102, makes a DNS (Domain Name Service) request to the ISP for the IP address of the domain portion of the HTTP request. The ISP, 104, puts out a DNS request on the Internet, 104, requesting that any authoritative DNS server for this domain respond with the IP address of the server. An authoritative DNS server, 105, responds to the request by providing the IP address of the domain. The ISP, 104, then responds back to the DBWT, 101 or 102, with the IP address of the domain and the DBWT begins a dialog with the domain by requesting the base HTML (Hypertext Markup Language) page of the domain.

The IP address will identify a specific web server, 106, to which all requests for any information from the domain identified are sent. The web server will then respond with the base HTML page to the DBWT, 101 or 102, which will be routed over the Internet, 104. The DBWT, 101 or 102, upon receipt of the response from the web server, 106, will scan the response to see if there are additional requests that must be made to compile and present to the viewer of the site on the DBWT the complete page as desired by the site. This means that additional sites and HTTP requests will likely be made to gather all of the data elements (graphics, text, advertisements, inserts, add-ins, etc.) that comprise the completed and finally rendered page.

For each additional request that must be made the DBWT, 101 or 102, will identify if the domain providing the data element is one for which the IP address is known. If not, then the DBWT, 101 or 102, will, as indicated above, make a DNS request to the ISP, 104, which will result in an authoritative DNS server, 105, responding with the IP address of the requested domain. This IP address will then be used by the DBWT, 101 or 102, to make an HTTP request to the web server, 106, of the site for the data element desired. If the IP address of the domain is known then the DBWT, 101 or 102, will not need to make the additional DNS request and will just proceed with the HTTP request for the data element which could be from a web server, 106, a content server, 107 or a database server, 108.

With each response to each HTTP request the DBWT, 101 or 102, will scan the response to identify any additional data elements required before the page can be fully rendered. This process can result in hundreds of individual HTTP requests to just present a single page of a site to the viewer on the DWBT. And this dialog for this single page is just one in a sequence of page dialogs for the viewer utilizing this particular DBWT.

The basis for the communication between the DBWT, 101 or 102, and ISP, 104, is TCP/IP (Transaction Communication Protocol/Internet Protocol) that was developed by DARPA in the late 60's and implemented in the early 70's as a survivable communications protocol for distributed communications.

HTTP is the base protocol by which any web page, image, text, video, audio, slide show, and/or any other content is presented within a DBWT, 101 or 102, to the Internet, 104. HTTP is the non-secure (as opposed to the secure HTTPS—http Secure) protocol by which all DBWTs communicate with websites, 106, 107 or 108, utilizing TCP/IP as the network layer communication protocol. TCP/IP is a packet communications protocol upon which Internet communications is based.

The action(s) taken by the DBWT, 101 or 102, will be governed by the HTTP protocol standards that have been established by the World Wide Web Consortium (W3C) and each HTTP request will, according to existing network protocols, be broken down into a series of network packets that will be exchanged in a request/response dialog between the DWBT and the website to which the request is issued.

The HTTP dialog is conducted through a series of packets communicated between the DBWT, 101 or 102, and website, 106, 107 or 108. In a typical HTTP request for a web page there will be hundreds of http requests which will result in millions of TCP/IP packets of exchanges between the DBWT, 101 or 102, and the website, 106, 107 or 108.

Packets can vary in size, according to the protocol definition, from tens of bits to tens of thousands of bits.

Each packet in both directions (request and response) will be captured by the data capture appliance.

Each packet comprises a variable structure containing a header and a data body. The purpose of the header is to enable the reading of the data body and to sequence this packet in serial with the packet immediately before and immediately after in the communications string.

The data elements comprising the packet level interaction are identified in Table 1.

TABLE 1
Packet level data elements

| Data Element Name | Description |
|---|---|
| Date | Date of packet |
| Time | Time of packet |
| Status | http status returned to the client |
| Comment | http message returned to the client |
| Method | http method of the request |
| Request | Exact request line from the client |
| Referrer | Referrer request header |
| Cookie | Cookie request header |
| Set Cookie | Set Cookie response header |
| Client content type | Content type request header |
| Content type | Content type response header |
| Location | Location of response header |
| Cached | 1 if response was cached, 0 if not cached |
| Site name | Internet service name and instance running |
| | the client |
| Client version | Protocol version that client used |
| Proxy IP | IP of closest proxy server |
| Client IP | IP of client |
| Server IP | IP of server |
| Client MAC | MAC address of client |
| Server MAC | MAC address of server |
| Client port | Client port number of http request |
| Server port | Server port number of http response |
| Client packets | Number of packets sent to server |
| Server packets | Number of packets sent from server |
| Client ack packets | Number of ack packets sent to server |
| Server ack packets | Number of ack packets sent from server |
| Client missing packets | Number of packet gaps in request |
| Server missing packets | Number of packet gaps in response |
| Client duplicate packets | Number of duplicate packets in request |
| Server duplicate packets | Number of duplicate packets in response |
| Client data packets | Number of packets received by client |
| Server data packets | Number of packets sent to server |
| Client bytes | Number of bytes sent to server |
| Server bytes | Number of bytes sent to client |
| Request status | http request status |
| Response status | http response status |
| TCP status | TCP handshake status |
| SSL version | SSL protocol version used for encryption |
| Client content | Payload content sent to client |
| Server content | Payload content sent to server |
| Client headers | All http headers sent to server |
| Server headers | All http headers sent to client |
| Robot | 1 if packet originated from a robot, else 0 |

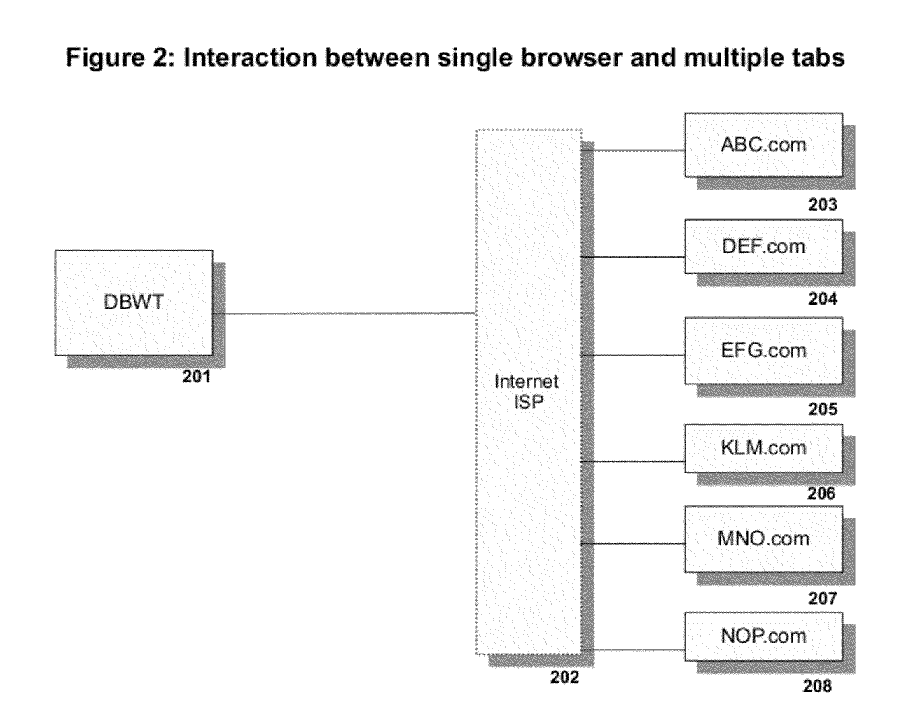

Referring to FIG. 2, a single browser can have multiple tabs and thus has the capacity to handle multiple customer interactions at the same time. FIG. 2 further illustrates the complexities (and resulting available, minable insights) of the array of sites and browsers that comprise the Internet.

FIG. 2 illustrates the relationship between DBW tabs with respect to the visit path. This description identifies the degenerate case where there are no DBW tabs and, thus, each DB Window would, in effect, be a DBW tab. This case is typical of mobile devices where the manufactures (Nokia, Droid, Apple, LG, et. al) have configured the browsers on these devices to open one and only one window with no tabs possible. In these cases the visit path is then based on the DB as opposed to the laptop/desktop device options where Browsers can have Windows and Windows can have Tabs.

The description will be done with DBWT, with full understanding that the above referenced configurations will change the nomenclature. The DBWT, 201, begins the visit with a request to ABC.com, 203, through the ISP, 202. The communication between user and ISP for all requests described herein will be done as described in FIG. 1.

Following the dialog with ABC.com, 203, the DBWT visit then moves to NOP.com, 208. NOP.com, 208, which links to KLM.com, 206, and EFG.com, 205. The requests for all three domains are represented in the page(s) dialog between the DBWT, 201, and the NOP.com site, in this case, 208.

Following the dialog with NOP.com, 208, the visit then moves to DEF.com, 204. DEF.com, 204, which links to KLM.com, 206, and NOP.com, 208, and the requests for all three domains are represented in the page(s) dialog between the DBWT, 201, and the DEF.com site, in this case, 204.

The path for this DBWT, 201, is comprised of three distinct sessions with three different sites: ABC.com, 203, NOP.com, 208, and DEF.com, 204.

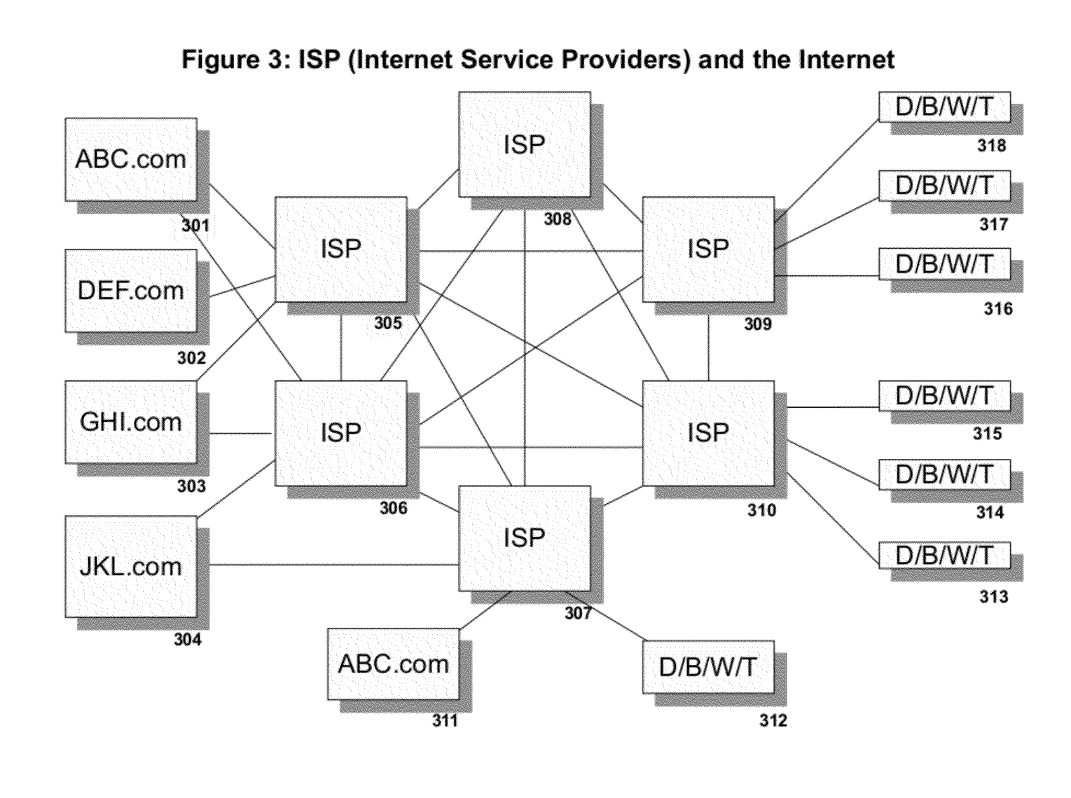

FIG. 3 further illustrates the complexity and resulting value of Internet communications methods and protocols. The ISPs, 305, 306, 307, 308, 309 and 310 are merely representative of the hundreds of thousands of ISP servers spread geographically worldwide.

In FIGS. 3, 301, 302, 303 and 304, along with DBWTs, 311, 312, 313, 314, 315, 316 and 317 are connected to the Internet, 305-310. In addition, although not illustrated in FIG. 3 DNS servers, content servers, database servers, web servers, etc. as illustrated in FIG. 1 are also present on the Internet.

Asynchronously to each other, DBWTs, 311-317, make requests to web sites, 301-304, utilizing the mechanisms described in FIG. 1 over the Internet, 305-310.

Each HTTP request from a DBWT as shown in 316, to a site, as shown in 303, will be comprised of many TCP/IP packets. Those packets will traverse the Internet, 305-310, through a variety of paths which controlled by the balancing of supply and demand of bandwidth within the ISPs, 305, 306, 307, 308, 309 and 310, and between the ISPs (e.g. 305-306, 305-307, 305-308, 307-308, 307-309, 309-310, etc.) for all possible combinations of ISPs directly connected to each other. As allowed by the TCP/IP protocol the packets have integrity within themselves to preclude errors, so that if a packet is formed incorrectly it will not process and its contents be ignored. Each packet is linked to its predecessor, if any, and to its follower, if any. To reflect accurately the visit path between the DBWT, 316, and the site, 303, the packets must be reassembled in the exact order from their origin which on a request would be the DBWT, 316, and on a response from the site, 303.

The value of the protocol is that the packets are transmitted from the source with an IP designator for the destination. The protocol enables the packets to follow different paths from source to destination. Their subsequent reassembly in sequence of the packets ensures the integrity of the resulting message (request or response). The packets can arrive out of sequence, which means that some requests will arrive before their predecessors. This results in (frequently substantial) processing involved in a reassembly process, as opposed to simply selecting the next packet. Thus, a simple request from DBWT, 312, to a site, 302, could result in packets following the paths 312-310-309-308-305-302, 312-310-307-306-302, 312-310-305-302 among others.

Measurement at the packet level is done for each request and the resulting data collected. When the request has completed then additional data is calculated. Both the collected and calculated data is represented in Table 2, HTTP Request Level Data Elements.

Irrespective of which ISP or individual website may have originated content, the packets collected from the data stream are sequenced into the http request as it originated from the client device browser window and tab. From the request the data elements in Table 2 can then be derived.

TABLE 2
HTTP request level data elements

| Data | |
|---|---|
| Element Name | Description |
| Date-time | Date and time of the request |
| Epoch-time | Number of seconds since epoch (Jan. 1, 1970) |
| Clf-date | Date and time of event (CLF format) |
| Request-start-time | Date and time of request start |
| Request-end-time | Date and time of request end |
| Response-start- | Date and time of response start |
| time | |
| Response-end- | Date and time of response end |
| time | |
| Uri | Requested resource (including query string) |
| Uri-stem | Requested resource (without query string) |
| Uri-query | Query portion of requested resource |
| RFC931 | Remote logname of user making request |
| Authuser | Username as which the user has authenticated itself |
| Bytes | Total number of bytes transmitted for request |
| | and response |
| Time-taken | Microseconds to complete http request at client |
| Cs-send-time | Microseconds for client to make request |
| Cs-ack-time | Microseconds for server to acknowledge client request |
| Sc-reply-time | Microseconds to start of response |
| Sc-send-time | Microseconds to complete response |
| Sc-ack-time | Microseconds for client to acknowledge response |
| | receipt |
| Ssl-time | Microseconds elapsed to establish SSL handshake |
| Data-center-time | Microseconds from last rqst packet to last |
| | response packet |
| Cp-rtt | Average microseconds from client to appliance |
| | by packet |
| Ps-rtt | Average microseconds from appliance to server |
| | by packet |
| Cp-rtt-sum | Total microseconds from client to appliance |
| Ps-rtt-sum | Total microseconds from appliance to server |
| Cp-rtt-packets | Total number of measurements client to appliance |
| Ps-rtt-packets | Total number of measurements appliance to server |
| Page-load | Microseconds to load page |
| Page-load-redirect | Microseconds to redirect a page view |
| Page-load-base | Microseconds to load page HTML |
| Page-load-content | Microseconds to load page content |
| Session-group | Group to which a visit session is assigned |
| Session-id | Unique identifier assigned to all visits of this session |
| Visitor-id | Unique identifier assigned to a visitor across all |
| | sessions |
| Cookie-id | Name value pair associated with the set cookie |
| | response |
| Page number | Page number of this page in sequence of visit to site |
| Request number | HTTP request sequence number for this page |
| Page title | Title of page extracted from HTML content of page |
| Page content | Response content for the http-event which triggered |
| | page |
| New page | 1 if the http event triggered a new page |
| New-session | 1 if the http event triggered a new session |
| Page object | 1 if the http event matched page object detection rules |
| Page hits | Number of http requests associated with this page |
| Page dwell | Number of seconds on page prior to next http event |

Once a session has concluded either by the DBWT closing or the user moving to a different URL, then another session will be established. The following parameters will be derived for the precursor clicks while on this site as identified in Table 3.

TABLE 3
Session level parameters derived from HTTP requests

| | |
|---|---|
| Session pages | Number of page views requested during this session |
| Session hits | Number of http requests during this session |
| Session dwell | Number of seconds for the session |
| Session length | Number of seconds between first an last request |
| Session duration | Number of seconds between first request and end |
| | of last response |
| Visitor status | New visitor: c = Cookie, v = VisitorDB, a = AnonDB |
| Content-id | Unique MD5 hash of response content |

TABLE 4
Creating a Site Pathway for DBWT

| | |
|---|---|
| Site name | Domain name of site visited |
| Time on site | Amount of time spent on site |
| | (first request to last response) |
| Date/time start | Date and time of first request |
| Date/time end | Date and time of last request |
| Total pages | Number of pages rendered |
| Total bytes | Number of bytes delivered to client |

The request data is compiled for each request as seen in data collection. When all requests have been completed then the session can be marked complete and the session is now ready for session processing.

In an embodiment, the data capture appliance will extract, retain, tag and incrementally assemble the dialog as it occurs in a bi-directional manner—request/response. Packets are processed continuously with stated changes established based on visits, sessions within visits, pages within sessions, request/response within pages and packets within request/responses.

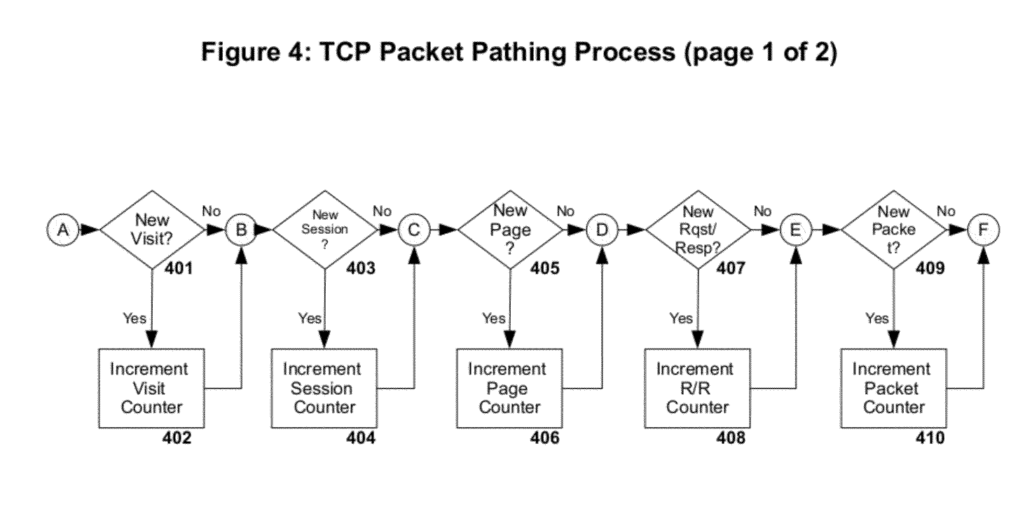

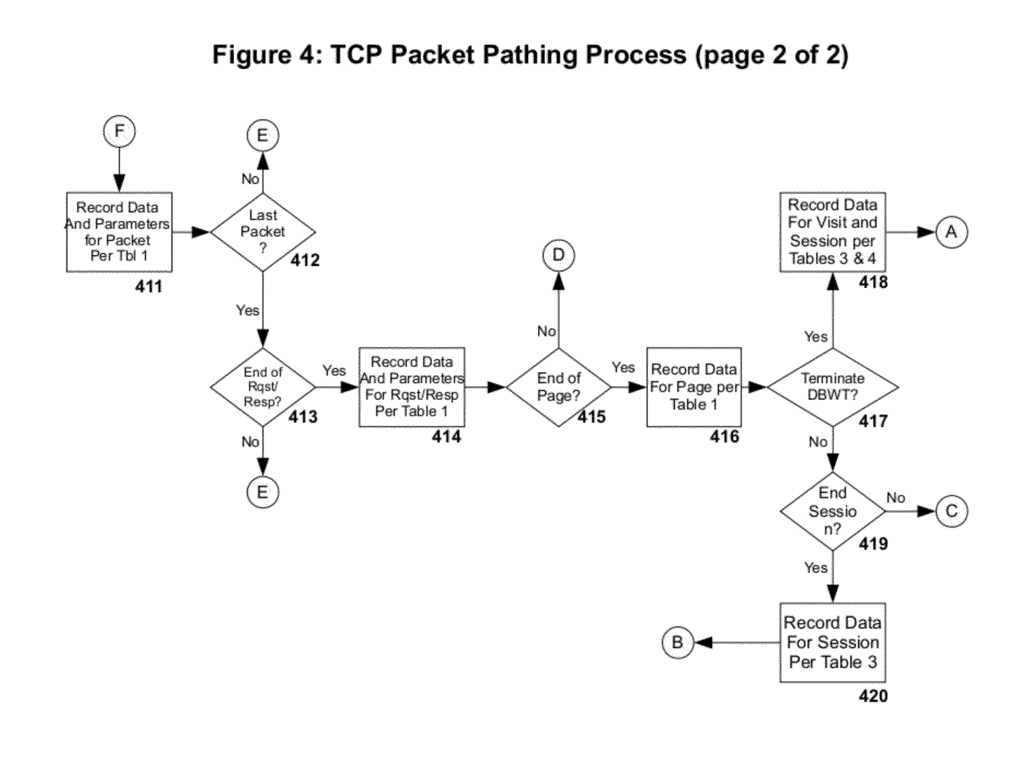

This process is illustrated in FIG. 4.

The decision logic begins with whether this is a new visit, block 401, and if so then the visit counter is incremented by one, block 402. The first packet of the request will key a sequence number increment and the storage of IP addresses, time, date, acknowledgement and data as indicated in Table 1 request data.

At block 403, a determination is made whether this is a new session within the visit and if so then the session counter is incremented by one, block 404.

At block 405, a determination is made whether this is a new page within the session and if so then the page counter is incremented by one, block 406.

At block 407, a determination is made whether this is a new request/response with the page and if so then the request/response counter is incremented by one, block 408.

At block 409, a determination is made whether this is a new packet within the request/response and if so then the packet counter is incremented by one, block 410.

At block 411, the packet data and parameters are recorded in accordance with the data elements in Table 1.

At block 412, a determination is made whether this is the last packet, if not then processing resumes at block 409.

At block 413, a determination is made whether this is the end of a request/response and if not, processing resumes at block 409.

At block 414, the records the data and parameters are recorded for the request/response in accordance with the data elements in Table 1.

At block 415, a determination is made whether this is the end of a page and if not then processing resumes at block 407.

At block 416, the records, the data, and parameters are recorded for the page in accordance with the data elements in Table 2.

At block 417, a determination is made whether the DBWT has been terminated and if so, records the data for the visit and session in accordance with the data elements in Tables 3 & 4.

At block 419, a determination is made whether this is an end of session and if not, processing resumes at block 415. At block 420, records data for the session are recorded in accordance with Table 3, processing resumes at block 403.

When the DBWT starts all counters are defaulted to zero or null.

Data Collection

In an embodiment, the browser path analyzer comprises a data capture appliance. The capture appliance is inserted into an ISP data stream. The capture appliance captures the HTTP requests made by a browser and processes the HTTP requests. In an embodiment, the capture appliance may be implemented on a computing device comprising a processor, a memory, storage components, I/O components and software. In another embodiment, the capture appliance is a custom device. The HTTP protocol is sequenced above the TCP/IP protocol.

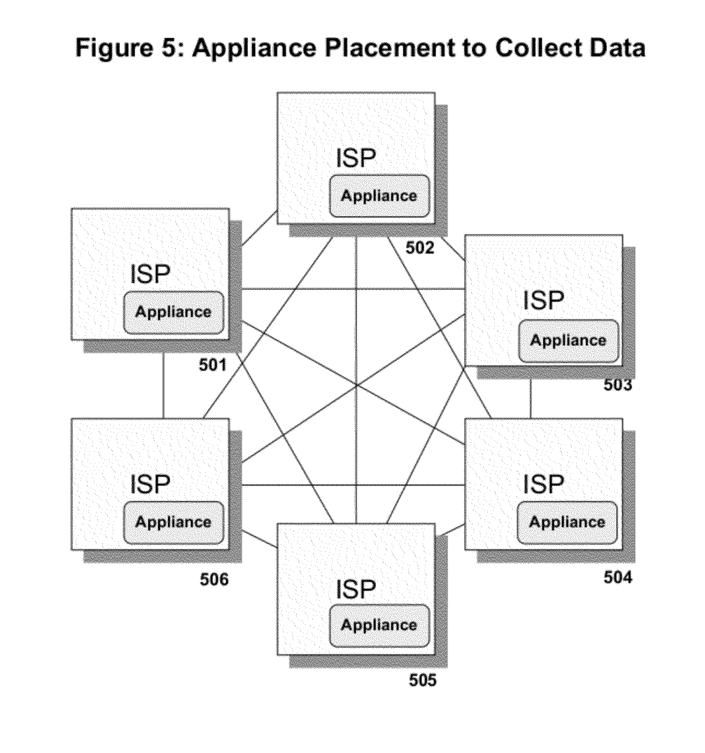

In an embodiment, the relationship of a browser and an ISP are leveraged to non-intrusively tap into the communications between the browser and ISP (on the ISP side of the interface) and record the packets that manifest a “distinct click” using the http port 80 (non-secure) TCP/IP protocol. FIG. 5 is a block diagram illustrating a distribution of capture appliances according to an embodiment. A capture appliance may be utilized to collect information on the visit paths of DBWTs. Illustratively the Internet is comprised of ISPs, 501-506, with redundant connectivity between each ISP.

To ensure accurate collection of the visit traffic for the DBWTs, a collection appliance is installed “up line” (i.e. separated from the traffic) of a digital communications network, of the DBWT connections to the ISP, 501-506. Placing capture appliances at ISP locations provides the ability to capture the total view of information.

FIG. 5 also illustrates that the capture appliances will be configured with very little code in order to capture the large volumes of data being transmitted. Internet bandwidth communication speeds demand that a capture appliance be able to process data streams in excess of tens of billions of bits per second. The data elements that will be extracted from each packet for subsequent storage are listed in Table 1. In addition, there are data elements that must be contextually maintained so as to enable the appliance to reconstruct the packet sequence so that the http request can be reconstructed.

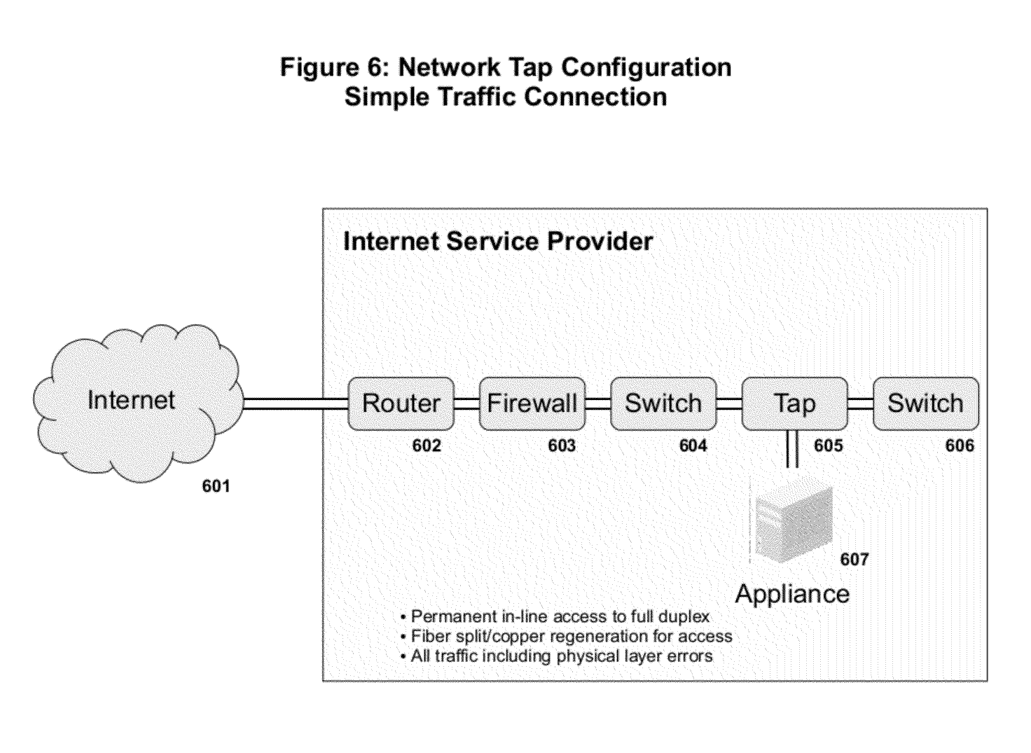

FIG. 6 is a block diagram illustrating an interface of a capture appliance to an existing network using a tap according to an embodiment. In this embodiment, data is collected in much the same way as a tape recorder passively “collects” a conversation between people.

In an embodiment, a capture appliance uses a network tap as the source for the full duplex traffic through the ISP infrastructure (602-606). It should be noted that the network and components described are generic and the exact configuration may or may not be the configuration to which the capture appliance, 607, is connected. However, functionally, all networks will accomplish the same end result of providing the capture appliance, 607, with the data-stream.

The Internet, 601, connection will be handled by a router, 602, which will then interface to a firewall, 603, which will connect to a switch, 603. The switch, 603, is then used to literally switch the traffic stream to different devices, in whole or in part, or to multi-stream the traffic, in whole, to many devices.

A whole data stream will move through a tap, 605, which provides no data loss, no latency stream processing to passive devices. The tap, 605, has output ports that are simplex, meaning that the data flows in only one way—out. In this way the tap is truly a passive device to capture traffic off the network. The tap, in addition to passing data to the appliance, supports the stream process by also passing the stream to a switch, 606.

The capture appliance, 607, receives the data-stream from the network for processing and since the tap is passive, the capture appliance is passive and cannot, in any way, impede the performance of the network at any point or in any manner.

In an embodiment, each packet in both directions (request and response) may be captured by the data capture appliance and re-sequenced.

The data elements that will be extracted from each packet for subsequent storage are listed in Table 1. In addition, there are data elements that must be contextually maintained so as to enable the data capture appliance to reconstruct the packet sequence so that the http request can be reconstructed.

Data Storage

In an embodiment, the data capture appliance is configured to retain information in memory and on local disk, depending on 1) parameters set during the installation of the data capture appliance on a network; 2) through subsequent updates made locally to the data capture appliance, and/or 3) remotely by appliance administrators. On a predefined basis the data capture appliance transfers its locally housed data to a datastore for the next phase of processing.

In an embodiment, a collection datastore receives data fragments from any and all capture appliances attached to the Internet. The fragments are the data elements collected and derived from the packets that the capture appliance collects and processes. The packets are arranged in their original sequence to formulate the individual http requests generated by the user in their device browser window and tab.

In an embodiment, the relationship of a browser and an ISP is utilized to non-intrusively tap into the communications between the browser and the ISP (on the ISP side of the interface) and record the packets that manifest a “distinct click” using the http port 80 (non-secure) TCP/IP protocol.

The packets would record all useful information germane to the “distinct click” and will store this in a unique data store for real time access and subsequent processing. Once a click (the action/reaction between the browser and source website) has been satisfied the relevant data from the packets may be linked and marked in the unique data store as a “click” and this click may be associated to a “session” which was instigated by the opening of a browser tab/window.

In an embodiment, the http requests are segmented in time order by website within the domain of the device browser window and tab. This segmentation results in a complete path and content history of the web sites visited in time sequence with all associated content, timing and packets for a specific device browser window and tab. The set of data elements that provide the ability to query on these results is appended to the request data in the visit session.

In another embodiment, the http requests are also segmented by device browser instance so that the request made through each browser opened on the device can be determined. This segmentation results in a complete history of all visits to all websites by any browser on the device during any specified period of time. The set of data elements that provide the ability to query on these results are appended to the request data in the visit session(s).

Data Analysis

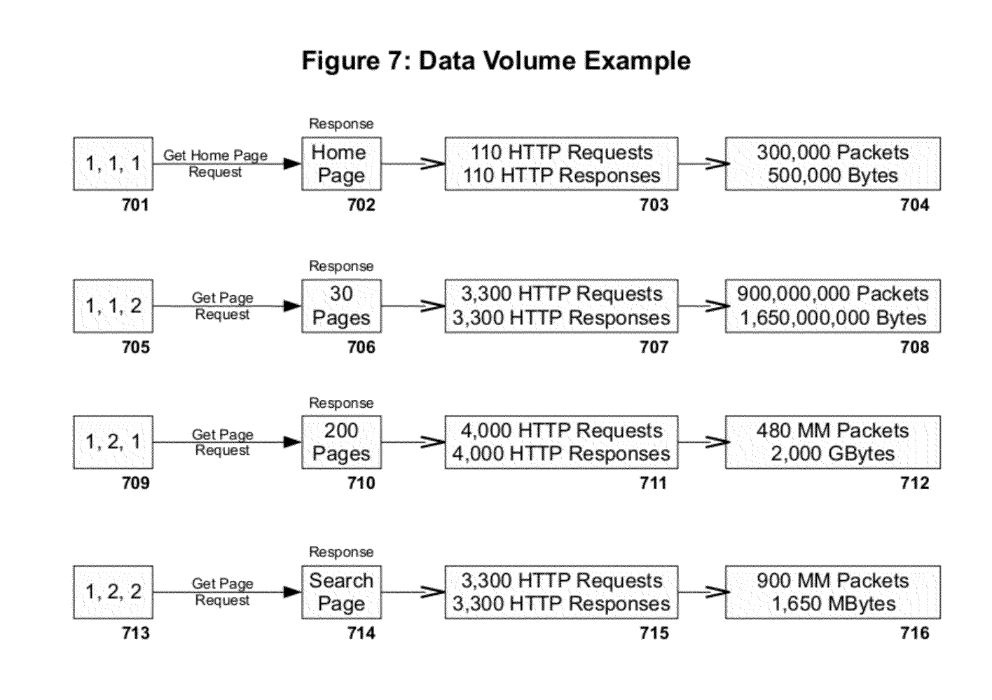

FIG. 7 is a block diagram illustrating the scale of the data to be analyzed through an example. One device, such as a desktop computer, two browsers (Internet Explorer and Firefox) and two tabs are opened in each browser. That is four instances of device browser window and tab (1,1,1), block 701, (1,1,2), block 705, (1,2,1), block 709 and (1,2,2), block 713, where (x, y, z) refers to (browser, window, tab within device).

In this example (1,1,1), block 701 requests my.yahoo.com, which is a persistent customized home page that automatically refreshes by approximately 40-45 minutes with news, stock quotes, and other content customized by the user. Tab (1, 1, 2), block 705, is a Google window where searches are conducted on various terms, ideas, etc. Tab (1, 2, 1), block 709, is a window through which the user is doing remote access to the corporate network email program, web based Outlook. And, tab (1, 2, 2), block 713, is a window through which the user is visiting sites of interest through Google search.

Tab (1, 1, 1), block 701, renders each page, block 702, through approximately 110 http requests, block 703, based on the settings for this user. Those 110 http requests result in approximately 300,000 packets to be exchanged by the tab and Yahoo for the actual content and packets for metering the data flow. The number of bytes per page is, on average, 500,000, block 704. The page is regenerated every forty minutes over the course of an eight hour work day or roughly 10 times for a total of 1,100 requests, 550 megabytes of data response and 330 million packets to process, store and analyze.

Tab (1, 1, 2), block 705, renders a Google page and then some specific site page(s) and content as the user goes about business. If the user uses a) 30 pages, block 706, b) 110 requests per page generating approximately 300,000 packets, and c) an average of 500,000 bytes per page, there is a total of 3,300 requests, block 707, 1,650 megabytes of data response and 900 million packets for this tab, block 708.

Tab (1, 2, 1), block 709, is the remote email window that will most likely be heavily used. However, since email pages are smaller the user will generate a) 20 requests per page, block 710; b) 200 pages over the course of the working day because of email volume for a total of 4,000 requests, block 711, 2,000 gigabytes of data response and 480 million packets, block 712.

Tab (1, 2, 2), block 713, is a search for specific site tab. Assuming the same work as Tab (1, 1, 2), block 705, there are 3,300 requests, block 715, 1,650 megabytes of data response and 900 million packets, block 716.

As illustrated in the example, FIG. 7, for the computing device as configured, approximately 11,700 requests, 5,850 megabytes of data response and 2.5 billion packets will be generated over the course of eight hours, block 704, block 708, block 712, block 716.

As described above, the data capture appliance captures and/or derives and stores approximately 100 data elements that average 64 bytes of data each.

As described above, the data collection appliance captures and/or derives and stores approximately 100 data elements that average 64 bytes of data each.

Some of the advantages of this approach are:

a) Significant reduction in data storage to record the entire click history of the session without data loss.

b) The dramatic reduction in the amount of data stored for a visit path of a device/browser/tab significantly enhances the ability to query the reduced amount of data.

c) The embodiments herein provide for response times to actions measured in sub-second timeframe. Current state of the art as practiced by leading vendors including Nielsen, Omniture, CoreMetrics and others compares similar response times in days, sometimes weeks.

d) The path and content history captured for the visit(s) renders obsolete the “last click” attribution that is the current state of the art.

e) The path and content history captured for the visit(s) renders obsolete the existing method and system of usage monitoring, i.e. KPI's, including but not limited to “unique visitors”, “top referring sites”, etc, as described in paragraphs 33-40.

f) Storage of data in a parallel data structure enables faster access to data using parallel query techniques. This is a significant improvement over the current state of the art that uses the extant row/column storage accessed by SQL paradigm.

Embodiments are directed to using peers to provide additional bandwidth for the communication of a data.

As memory and disk on the data capture appliance are consumed, a trigger on the data capture appliance “exports” the data collected and derived to the data store. The data store integrates the newly arrived data with existing data to form comprehensive, to-date, paths for DBWTs.

The data in the data store is utilized for research and reporting. In an embodiment, the datastore provides this data in parallel-mesh architecture so that many simultaneous queries can be asserted against the datastore in rapid and responsive manner. There is no notion of row/column with SQL data storage within the data store since the size of the datastore, billions of rows (in relational measures), would render any relational implementation as completely unresponsive and not queriable.

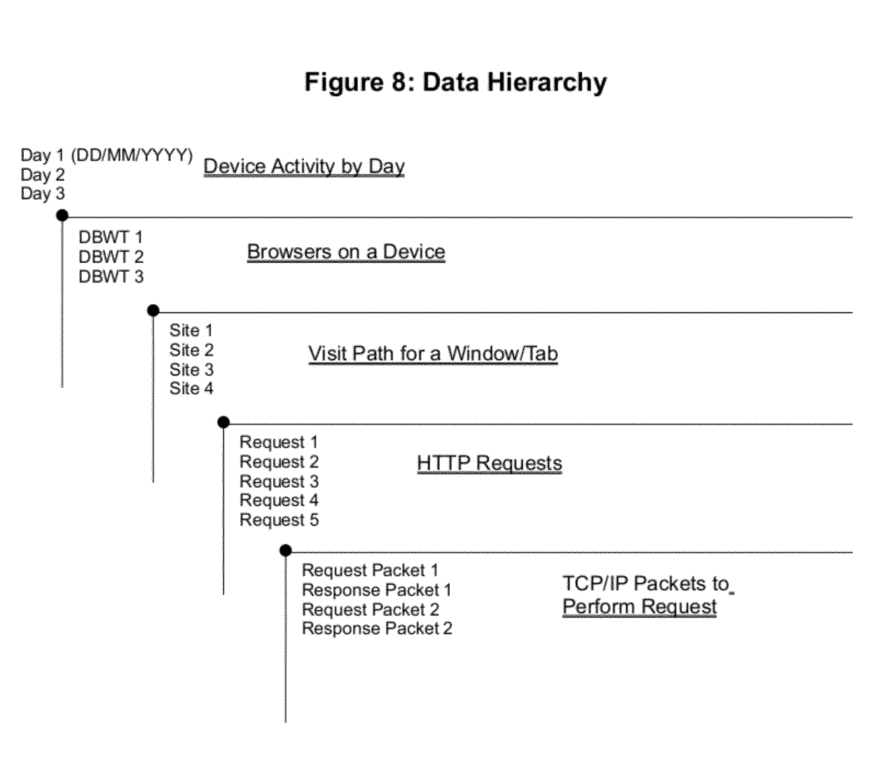

FIG. 8 is a chart illustrating a hierarchy for data collection according to an embodiment. As illustrated, users can simultaneously have multiple devices, browsers, windows and/or tabs requesting information from the Internet. Request 1 is performed before request 2 and so on. The TCP/IP packets (as illustrated in Table 5) contain the data for these requests that are captured through one of the taps illustrated in FIG. 6. This enables the software to sort the aggregated data by browsing, carting, revisiting or any other behavior (or group of behaviors) by examining the sites visited and the content consumed within the context of the behavior exhibited by a browser/visitor.

TABLE 5
TCP pseudo-header (IPv6)

| | | | | |
|---|---|---|---|---|
| Bit offset | 0-7 | 8-15 | 16-23 | 24-31 |

| 0 | Source address | |
|---|---|---|
| 32 | | |
| 64 | | |
| 96 | | |
| 128 | Destination address | |
| 160 | | |
| 192 | | |
| 224 | | |
| 256 | TCP length | |
| 288 | Zeros | Next header |

| 320 | Source port | | | Destination port |
|---|---|---|---|---|
| 352 | Sequence number | | | |
| 384 | Acknowledgement number | | | |
| 416 | Data | Reserved | Flags | Window |
| | offset | | | |

| | | |
|---|---|---|
| 448 | Checksum | Urgent pointer |

| | |
|---|---|
| 480 | Options (optional) |
| 480/512+ | Data |

The functional and structural aspect of the various embodiments may be useful in any number of industries. By way of illustration and not by way of limitation, the following are examples of such industries:
The real estate industry may find this useful because information relating to usage can be analyzed, reported and correlative trends established.
The pharmaceutical industry may find this useful because information relating to usage can be analyzed, reported and correlative trends established.
The medical industry may find this useful because information relating to usage can be analyzed, reported and correlative trends established.
The utilities industry may find this useful because information relating to usage can be analyzed, reported and correlative trends established.
The transportation industry may find this useful because information relating to usage can be analyzed, reported and correlative trends established.
The retail industry may find this useful because information relating to usage can be analyzed, reported and correlative trends established.
The e-commerce industry may find this useful because information relating to usage can be analyzed, reported and correlative trends established.
The video amusements and entertainment industry may find this useful because information relating to usage can be analyzed, reported and correlative trends established.
The security industry (including but not limited to residential, business and private) may find this useful because information relating to usage can be analyzed, reported and correlative trends established.
The printing industry, including anything published and/or printed, commercial or otherwise, may find this useful because information relating to usage can be analyzed, reported and correlative trends established.
The automobile industry may find this useful because information relating to usage can be analyzed, reported and correlative trends established.
The “sight and hearing impaired” aids industry may find this useful because information relating to usage can be analyzed, reported and correlative trends established.
The advertising and media industry may find this useful because information relating to usage can be analyzed, reported and correlative trends established.
The iron and steel industry may find this useful because information relating to usage can be analyzed, reported and correlative trends established.
The finance and investments industry may find this useful because information relating to usage can be analyzed, reported and correlative trends established.
The insurance industry may find this useful because information relating to usage can be analyzed, reported and correlative trends established.
The residential and business environments industry may find this useful because information relating to usage can be analyzed, reported and correlative trends established.
The electronics industry may find this useful because information relating to usage can be analyzed, reported and correlative trends established.
The travel industry may find this useful because information relating to usage can be analyzed, reported and correlative trends established.
The boating industry may find this useful because information relating to usage can be analyzed, reported and correlative trends established.
The entertainment industry may find this useful because information relating to usage can be analyzed, reported and correlative trends established.
The political industry (including but not limited to candidates, polling, issues and related topics) may find this useful because information relating to usage can be analyzed, reported and correlative trends established.
The music industry (including but not limited to publishing, recording, distribution and sales) industry may find this useful because information relating to usage as well as file sharing and other activities can be analyzed, reported and correlative trends established.
The movie industry (including but not limited to production, digital, film, distribution and corporate and consumer viewing and sales) may find this useful because information relating to usage can be analyzed, reported and correlative trends established.

In summary, the various embodiments and methods illustrated herein collect and analyze broad categories of data such as site visit parameters for multiple websites, visit frequency parameters, site type parameters, transmission and download speed parameters, tag parameters, purchase parameters, content parameters, actual content served, equipment parameters, and statistical parameters.

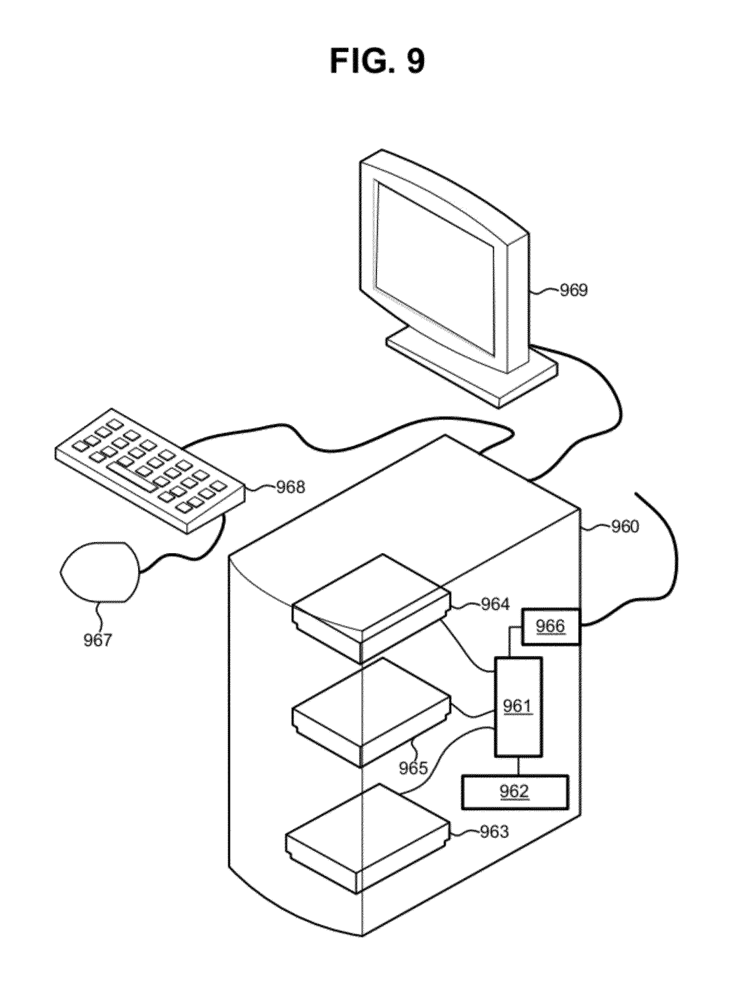

As previously described, the subscriber may interact with the various servers and network components using a variety of the computing devices, including a personal computer. By way of illustration, the functional components of a computing device 960 are illustrated in FIG. 9. Such a computing device 960 typically includes a processor 961 coupled to volatile memory 962 and a large capacity nonvolatile memory, such as a disk drive 963. The computing device 960 may also include a floppy disc drive 964 and a compact disc (CD) drive 965 coupled to the processor 961.

Typically the computing device 960 will also include a pointing device such as a mouse 967, a user input device such as a keyboard 968 and a display 969. The computing device 960 may also include a number of connector ports 966 coupled to the processor 961 for establishing data connections or network connections or for receiving external memory devices, such as a USB or FireWire® connector sockets. In a notebook configuration, the computer housing includes the pointing device 967, keyboard 968 and the display 969 as is well known in the computer arts.

While the computing device 960 is illustrated as using a desktop form factor, the illustrated form is not meant to be limiting. For example, some or all of the components of computing device 960 may be implemented as a desktop computer, a laptop computer, a mini-computer, or a personal data assistant.

A number of the embodiments described above may also be implemented with any of a variety of computing devices, such as the server device 900 illustrated in FIG. 9. Such a server device 900 typically includes a processor 901 coupled to volatile memory 902 and a large capacity nonvolatile memory, such as a disk drive 903. The server device 900 may also include a floppy disc drive and/or a compact disc (CD) drive 906 coupled to the processor 901. The server device 900 may also include network access ports 904 coupled to the processor 901 for establishing data connections with network circuits 905 over a variety of wired and wireless networks using a variety of protocols.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium.

Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers.

Combinations of the above should also be included within the scope of computer-readable media. Additionally, the operations of a method or algorithm may reside as one or any combination or set of codes and/or instructions on a machine-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A system for recording and analyzing internet browser traffic comprising:
a web server computing device associated with an internet service provider (ISP) connected to the internet;
computer storage media connected to the web server computing device; and
a tap engine;
wherein the web server computing device is configured to operate the tap engine causing the web server computing device to perform operations comprising:
collecting and storing user dialog information (“UDI”);
analyzing the UDI; and
wherein the UDI comprises site visit parameters for multiple websites, visit frequency parameters, site type parameters, transmission and download speed parameters, tag parameters, purchase parameters, content parameters, actual content served, equipment parameters, and statistical parameters.

2. The system of claim 1 wherein analyzing the UDI comprises cross referencing the UDI parameters one to another.

3. The system of claim 2, wherein cross referencing the UDI parameters comprises cross referencing at least two UDI parameters from the group consisting of site visit parameters, visit frequency parameters, site type parameters, transmission and download speed parameters, tag parameters, purchase parameters, content parameters, actual content served, equipment parameters, and statistical parameters.

4. The system of claim 1 wherein the analyzing of the UDI further comprises reconstructing the sequence of web pages visited by a user from the site visit parameters without the use of tagging or cookies

5. The system of claim 1 wherein the analyzing of the UDI further comprise reconstructing multiple internet browsing sessions from the site visit parameters.

6. The system of claim 1 wherein the analyzing of the UDI further comprises analyzing the equipment parameters associated with a user during a particular internet browsing session.

7. The system of claim 1 wherein the analyzing of the UDI further comprises a analyzing the site statistical parameters to determine the number of page viewed by site, by requests, by specific browsers, and by number of page views automatically generated.

8. The system of claim 1 wherein the analyzing of the UDI further comprises generating reports based on user pre-defined queries.

9. The system of claim 1 wherein the analyzing of the UDI further comprises analyzing end-to-end efficacy of online advertising and marketing campaigns.

10. The system of claim 1 wherein the analyzing of the UDI comprises real-time analysis and reporting of UDI.

11. The system of claim 1 wherein the analyzing of the UDI further comprises calculating the time for server browser requests from specific web servers.

12. The system of claim 1 wherein the rules for analyzing the UDI further comprises graphically displaying stored data in real time to a user.

13. A system for recording and analyzing internet browser traffic comprising:
a tap computing device, wherein the tap computing device comprises a processor inserted into a data stream between an ISP web server and a requesting internet browser, and wherein the processor is configured for:
collecting and storing user dialog information (“UDI”);
analyzing the UDI; and
wherein the UDI comprises site visit parameters for multiple websites, visit frequency parameters, site type parameters, transmission and download speed parameters, tag parameters, purchase parameters, content parameters, actual content served, equipment parameters, and statistical parameters.

14. The system of claim 13 wherein the r analyzing of the UDI further comprises cross referencing the UDI parameters one to another.

15. The system of claim 14, wherein the cross referencing of the UDI parameters comprises cross referencing at least two UDI parameters from the group consisting of sites visited, visit frequency parameters, site type parameters, transmission and download speed parameters, tag parameters, purchase parameters, content parameters, actual content served, equipment parameters, and statistical parameters.

16. The system of claim 14 wherein the analyzing of the UDI further comprises reconstructing the sequence of web pages visited by a user from the site visit parameters without the use of tagging or cookies

17. The system of claim 14 wherein the analyzing of the UDI further comprises reconstructing multiple internet browsing sessions from the site visit parameters.

18. The system of claim 14 wherein the analyzing of the UDI further comprises analyzing the equipment parameters to determine the specific equipment used a user during a particular internet browsing session.

19. The system of claim 14 wherein the analyzing of the UDI further comprises analyzing the site statistical parameters to determine the number of page views by site, by requests by specific browsers and by number of page views automatically generated.

20. The system of claim 14 further comprises generating reports based on the analyzing of the UDI.

21. The system of claim 20 wherein the reports comprise end-to-end analysis of online advertising and marketing campaigns.

22. The system of claim 14 wherein the processor is further configured to allow real-time analysis and reporting on internet traffic.

23. The system of claim 14 wherein the analyzing of the UDI further comprises calculating the time for serving browser requests from specific web servers.

24. The system of claim 14 wherein the processor is further configured to allow graphical displaying UDI.

25. A method for analyzing internet browser traffic comprising
collecting user dialog information (“UDI”) by a tap engine processor;
storing the collecting UDI, wherein the UDI comprises parameters and wherein the collecting and storing by the tap engine processor occurs at an internet service provider's (“ISP”) server; and
analyzing the stored UDI by cross referencing the UDI parameters one to another.

26. The method of claim 25 wherein the cross referencing of the UDI parameters comprises cross referencing at least two UDI parameters from the group consisting of site visit parameters from multiple websites, visit frequency parameters, site type parameters, transmission and download speed parameters, tag parameters, purchase parameters, content parameters, actual content served, equipment parameters, and statistical parameters.

27. The method of claim 25 wherein the tap engine processor is contained within a web server processor associated with the internet service provider (ISP) connected to the internet.

28. The method of claim 26 wherein analyzing the UDI further comprises reconstructing a sequence of web pages visited by a user in an internet browsing session from the site visit parameters without the use of tagging or cookies.

29. The method of claim 26 wherein analyzing the UDI further comprises reconstructing multiple internet browsing sessions by a user over a period of time from the site visit parameters.

30. The method of claim 26 wherein analyzing the UDI further comprises analyzing the equipment utilized by the user during a particular internet browsing sessions from the equipment parameters.

31. The method of claim 26 wherein analyzing the UDI further comprises analyzing the number of page views by site, by requests by specific browsers and by number of page views automatically generated by sites from the site statistical parameters.

32. The method of claim 27 further comprising providing reports to a user.

33. The method of claim 26 wherein analyzing the UDI further comprises creating an end-to-end analysis of online advertising and marketing campaigns.

34. The method of claim 26 wherein analyzing the UDI further comprises real-time analyzing and reporting on internet traffic.

35. The method of claim 26 wherein analyzing the UDI further comprises calculating the time to serve browser requests from specific web servers.

36. The method of claim 26 wherein analyzing the UDI further comprises graphically displaying stored data.

37. A method for analyzing internet browser traffic comprising
collecting user dialog information (“UDI”) by a tap engine processor, wherein the tap engine processor is inserted into a data stream between an ISP web server and a requesting internet browser
storing the collecting UDI, wherein the UDI comprises parameters and wherein the collecting and storing by the tap engine processor occurs at an internet service provider's (“ISP”) server; and
analyzing the stored UDI by cross referencing the UDI parameters one to another.

38. The method of claim 37 wherein the analyzing of the stored UDI by cross referencing the UDI parameters one to another comprises analyzing and cross referencing UDI parameters from the group consisting of site visit parameters from multiple websites, visit frequency parameters, site type parameters, transmission and download speed parameters, tag parameters, purchase parameters, content parameters, actual content served, equipment parameters, and statistical parameters.
